(19) United States
(12) Patent Application Publication
(10) Pub. No.: US 2010/0114350 A1
(43) Pub. Date: May 6, 2010

(54) METHOD OF DETERMINING MESH DATA AND METHOD OF CORRECTING MODEL DATA

(75) Inventors: Yoshio Kanai, Utsunomiya-shi (JP); Koji Hara, Utsunomiya-shi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/571,713

(22) Filed: Oct. 1, 2009

(30) Foreign Application Priority Data
Nov. 4, 2008 (JP) 2008-283409
Mar. 12, 2009 (JP) 2009-059194
Mar. 12, 2009 (JP) 2009-059198

(51) Int. Cl. G06F 19/00

(52) U.S. Cl. 700/98

(57) ABSTRACT

A die fabricated based on reference model data is corrected, and the corrected die is measured with a measuring instrument to provide three-dimensional measured die data. Noise areas in the three-dimensional measured die data are identified and removed using a computer. The three-dimensional measured die data and the model data are placed in proximity to each other, and a stacking and deforming process is performed in order to project a model surface represented by the model data onto a measured data surface represented by the three-dimensional measured die data. The stacking and deforming process is performed only within a range of the model surface that corresponds to an area in which the die is corrected. Portions of the three-dimensional measured die data from which noise areas have been removed are complemented by the model data.

### CROSS-REFERENCE TO RELATED APPLICATION

This application is based upon and claims the benefit of priority from Japanese Patent Applications No. 2008-283409 filed on Nov. 4, 2008, No. 2009-059194 filed on Mar. 12, 2009 and No. 2009-059198 filed on Mar. 12, 2009, of which the contents are incorporated herein by reference.

### BACKGROUND OF THE INVENTION

1. Field of the Invention

The present invention relates to a method of correcting model data by correcting a die or a real model which has been produced based on model data serving as a reference, measuring the corrected die or the real model with a measuring instrument to thereby obtain three-dimensional measured data, and thereafter placing a first surface represented by the three-dimensional measured data in proximity to a second surface represented by the model data for comparison between the first surface and the second surface using a computer. The present invention is also concerned with a method of determining mesh data by measuring the surface shape of a workpiece with a measuring instrument to thereby obtain mesh data made up of a plurality of mesh elements, and thereafter identifying noise areas within the mesh data using a computer.

2. Description of the Related Art

Heretofore, it has been customary to produce a press die by designing the die from shape data of a formed article using a CAD system or the like to generate die data. Then, a numerical control (NC) program is created for machining a press die based on the die data, and a press die is machined in a first stage on a numerically controlled (NC) machine tool, which is operated by running the NC program. Since the machined press die in the first stage may not be able to produce formed articles of desired quality, it has been a general practice to check the press die based on formed articles, which actually have been produced utilizing the press die on a trial basis, and to correct the press die according to the results of the check.

Recently, it has been desirable to prepare a plurality of identical dies, and to press workpieces utilizing the dies for mass-production of final products. It has been customary to use a die which has been corrected as a first die, and then to produce a second die (or a repetitive die) which corresponds to the first die. For efficiently producing the second die, it is desirable to minimize corrections that may be required on the first die and which are made by a skilled worker.

According to Japanese Laid-Open Patent Publication No. 2006-320996, it is proposed to measure a produced first die with a three-dimensional measuring instrument, to generate a curved surface from three-dimensional point group data generated by the three-dimensional measuring instrument, and to generate NC machining data for shape machining based on data of the curved surface. The three-dimensional point group data generated by the three-dimensional measuring instrument may be in the form of mesh data, as disclosed in Japanese Laid-Open Patent Publication No. 11-096398.

Dies, such as upper and lower dies, for pressing articles having complex shapes, such as automobile panels, tend to develop and include clearances between mating surfaces thereof, which cannot be predicted from prototype dies and pressing simulations. Also, the prototype dies are liable to suffer from wrinkles and cracks. Therefore, it is necessary to repeat a process of correcting the dies and producing prototype dies again.

A die that is finally obtained, i.e., a first die, is produced as one die only. However, if doors for one side of an automobile, which are symmetrical to doors for the other side of the automobile, are to be manufactured after the die for the doors for the other side of the automobile has been produced, or if identical products are to be manufactured at a plurality of production sites, then one or more second dies, which are identical or symmetrical to the first die, may be produced.

For shortening the time required to produce such second dies, the three-dimensional shape of a corrected die may be measured, and the measured three-dimensional data may be reflected in die model data used for the second dies. The present applicant has proposed a method of reflecting measured three-dimensional data in die model data, as disclosed in Japanese Laid-Open Patent Publication No. 2008-176441. According to this proposed method, a surface represented by three-dimensional measured die data is placed in proximity to a surface represented by die model data, and absolute values of distances between a plurality of pairs of corresponding points on the surfaces are calculated. Thereafter, the die model data are corrected based on the calculated absolute values of such distances. The proposed method is capable of producing CAD data composed of smooth surfaces, as well as preventing corresponding points on the surfaces from being in a twisted association with respect to each other.

The method disclosed in Japanese Laid-Open Patent Publication No. 2008-176441 defines reference points made up of a plurality of polygons on a second surface represented by three-dimensional measured die data, and defines corresponding points on a first surface represented by corresponding die model data.

When the appearance of a vehicle is designed, model data may be prepared at some stage, and a clay model, which is generated based on the model data, may be corrected several times by the designer. In this case, it also is desirable to reflect the corrected clay model in the model data.

A first die, which is produced by correcting a die, may include noise therein such as pores caused upon correction of the die, screw holes for attaching parts to the first die, and scratches and steps, which are produced due to various reasons. Such noise should not be reflected in the shape surface data utilized for three-dimensional machining. If a first die is measured by a three-dimensional measuring instrument, as disclosed in Japanese Laid-Open Patent Publication No. 2008-176441 and Japanese Laid-Open Patent Publication No. 2006-320996, then since noise included in the first die also is measured, the computer operator needs to identify the location of such noise from the mesh data, and perform a predetermined correcting process on the mesh data in a subsequent process.

Japanese Laid-Open Patent Publication No. 11-096398 discloses that candidate meshes, which satisfy mesh evaluating standards and a mapping model, are displayed, so that the operator can select a desired mesh.

The amount of mesh data produced when the first die is measured by the three-dimensional measuring instrument is so large that it becomes burdensome for the operator to identify noise areas therein. The operator needs to be skillful enough to determine whether a certain area of mesh data includes a noise area or not.

According to the method disclosed in Japanese Laid-Open Patent Publication No. 2008-176441, in order to define reference points on a surface represented by three-dimensional measured die data as well as corresponding points on a surface represented by die model data, normal lines are set with respect to the reference points on the surface represented by the three-dimensional measured die data. Since the three-dimensional measured die data are produced by measuring the first die, which is an actual die, the three-dimensional measured die data represent slightly rough surfaces due to small machining marks and measurement errors caused by the measuring instrument. Therefore, it is preferable to set normal lines after a predetermined smoothing process (e.g., a relaxation smoothing process or the like) has been performed on the three-dimensional measured die data, rather than directly setting normal lines from the reference points. However, such a smoothing process is complex and time-consuming. In addition, inasmuch as an automobile body has a wide area, correcting the three-dimensional measured die data for all surfaces of the automobile body places an excessively large burden on the computer, and also is time-consuming.

### SUMMARY OF THE INVENTION

It is an object of the present invention to provide a method of determining mesh data while simply and reliably identifying noise areas from the mesh data.

Another object of the present invention is to provide a method of simply and efficiently correcting model data, which have been initially obtained from an actual die before the die is corrected, in order to match measured data that have been produced by measuring the actual die after it has been manually corrected, or by measuring a real model.

According to an aspect of the present invention, there is provided a method of correcting model data, comprising the steps of correcting a die fabricated based on reference model data, and measuring the corrected die with a measuring instrument to provide three-dimensional measured die data, and placing the three-dimensional measured die data and the model data in proximity to each other, and projecting a first surface represented by the model data onto a second surface represented by the three-dimensional measured die data using a computer. The step of projecting the first surface comprises a first step of determining normal lines or average normal lines including peripheral areas with respect to a plurality of reference points set on the first surface, a second step of determining intersecting points between the normal lines or the average normal lines and the second surface, and a third step of moving the reference points along the normal lines or the average normal lines to a position at a predetermined ratio up to the intersecting points, thereby providing a moved and corrected surface.

According to another aspect of the present invention, there is also provided a method of correcting model data, comprising the steps of correcting an actual model fabricated based on reference model data and measuring the corrected actual model with a measuring instrument to provide three-dimensional measured actual model data, and placing the three-dimensional measured actual model data and the model data in proximity to each other, and projecting a first surface represented by the model data onto a second surface represented by the three-dimensional measured actual model data using a computer. The step of projecting the first surface comprises a first step of determining normal lines or average normal lines including peripheral areas with respect to a plurality of reference points set on the first surface, a second step of determining intersecting points between the normal lines or the average normal lines and the second surface, and a third step of moving the reference points along the normal lines or the average normal lines to a position at a predetermined ratio up to the intersecting points, thereby providing a moved and corrected surface.

In the step of projecting the first surface, normal lines or average normal lines are determined with respect to a plurality of reference points set on the first surface, and the reference points are moved along the normal lines or the average normal lines. Consequently, both the three-dimensional measured die or actual model data and the model data do not need to be subjected to any type of special smoothing process. Therefore, the model data can simply and efficiently be corrected in order to match the measured data. The predetermined ratio referred to above includes a ratio of 100%.

The moved and corrected surface may be updated as the first surface. Further, the first step, the second step, and the third step may be repeated a plurality of times.

The reference points may represent vertices of polygons that make up the first surface, and the average normal line vectors may represent vectors produced by a weighted average of normal lines at vertices of polygons including the reference points and extending within a predetermined range around the reference points.

The method may further comprise the step of, after the step of projecting the first surface, performing an optimizing step to generate meshes based on a pseudo-curved surface in order to cause the moved and corrected surface, which ultimately is produced, to match predetermined accuracy conditions.

The step of projecting the first surface may be performed only within a range of the first surface, which corresponds to an area in which the die is corrected. Since the step of projecting the first surface is performed only within the range of the first surface, which corresponds to the area in which the die is corrected, the step of projecting the first surface can be performed rapidly.

The range of the first surface, which corresponds to the area in which the die is corrected, may be defined based on the distance between the first surface and the second surface after the three-dimensional measured actual model data and the model data, or the three-dimensional measured die data and the model data are placed in proximity to each other.

A threshold for the distance between the first surface and the second surface, which defines the range of the first surface that corresponds to the area in which the die is corrected, may be in a range from 0.05 mm to 0.2 mm.

The method may further comprise the steps of identifying noise areas within the three-dimensional measured die data, and removing the identified noise areas from the three-dimensional measured die data using a computer, and copying areas of the first surface, which correspond to the noise areas removed from the three-dimensional measured die data, onto portions of the three-dimensional measured die data from which the noise areas are removed.

With the method of correcting model data according to the present invention, model data originally obtained based on an object to be corrected can simply and efficiently be corrected in order to match the measured data.

According to still another aspect of the present invention, there is also provided a method of determining mesh data by measuring a surface shape of a workpiece with a measuring instrument to produce mesh data made up of a plurality of mesh elements and thereafter identifying noise areas with the mesh data using a computer, the method comprising a first step of identifying, within the mesh data, a predetermined reference node and all adjacent nodes that are adjacent to the reference node, with sides of the mesh elements interposed therebetween, a second step of determining an average surface with respect to the all adjacent nodes, a third step of determining a distance between the average surface and the reference node, and a fourth step of judging the reference node as a normal node if the distance is smaller than a predetermined threshold, or as a noise node if the distance is equal to or greater than the predetermined threshold.

Since the reference node is judged as a noise node if the distance between the average surface and the reference node is equal to or greater than the predetermined threshold, noise areas can simply and reliably be identified automatically by means of a computer.

If the average surface is determined according to a least square method based on all adjacent nodes, then the average surface can be determined appropriately.

The method may further comprise the step of, after the fourth step, identifying all mesh elements around the noise node as noise elements. The operator of the computer is thus able to easily recognize identified noise areas.

With the method of determining mesh data according to the present invention, since the reference node is judged as a noise node if the distance between the average surface and the reference node is equal to or greater than the predetermined threshold, noise areas can simply and reliably be identified automatically.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a flowchart showing the sequence of a preceding process prior to a method of determining mesh data according to an embodiment of the present invention;

FIG. 2 is a diagram showing mesh data by way of example;

FIG. 3 is a diagram, which is illustrative of the method of determining mesh data on a two-dimensional surface;

FIG. 4 is a flowchart showing the sequence of the method of determining mesh data according to the embodiment of the present invention;

FIG. 5 is a plan view showing a reference node and adjacent nodes within a portion of the mesh data;

FIG. 6 is a perspective view showing the reference node, adjacent nodes, and an average surface within a portion of the mesh data;

FIG. 7 is a diagram showing the reference node, adjacent nodes, and an average surface within a portion of the mesh data, which are projected laterally;

FIG. 8 is a view showing the mesh data with noise polygons identified therein;

FIG. 9 is a plan view of mesh data produced when the method of determining mesh data according to the embodiment of the present invention is attempted on a given workpiece;

FIG. 10 is a plan view of mesh data produced when another method of determining mesh data according to the present invention is attempted on a given workpiece;

FIG. 11 is a flowchart showing the sequence of a method of correcting model data according to an embodiment of the present invention;

FIG. 12 is a diagram showing a model surface and a measured data surface, from which noise areas have been removed;

FIG. 13 is a diagram showing the manner in which normal lines are set with respect to the model surface;

FIG. 14 is a first flowchart (1) showing a sequence of a stacking and deforming process;

FIG. 15 is a second flowchart (2) showing a sequence of a stacking and deforming process;

FIG. 16 is a diagram showing the manner in which a point within two or less nodes is extracted from given dividing points;

FIG. 17 is a diagram showing a weighting function;

FIG. 18 is a diagram showing the manner in which normal lines are set from a first layer surface;

FIG. 19 is a diagram showing a schematic two-dimensional representation of a plurality of moved and corrected surfaces, according to a stacking and deforming process;

FIG. 20 is a diagram showing a schematic three-dimensional representation of a plurality of moved and corrected surfaces, according to a stacking and deforming process;

FIG. 21 is a diagram showing an example in which normal lines are twisted between surfaces;

FIG. 22 is a diagram showing an optimizing process;

FIG. 23 is a diagram showing a complementing process; and

FIG. 24 is a flowchart showing the sequence of a method of correcting model data according to a modification.

### DESCRIPTION OF THE PREFERRED EMBODIMENTS

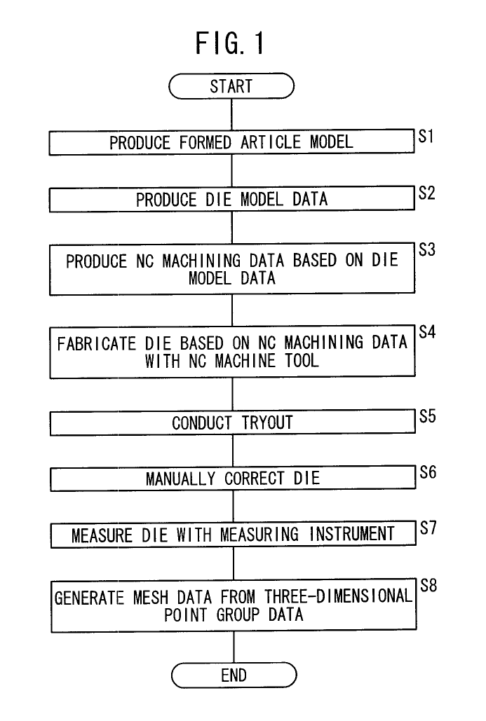

A method of determining mesh data according to an embodiment of the present invention will be described below with reference to FIGS. 1 through 10.

First, a preceding process, which takes place prior to the method of determining mesh data according to the present embodiment, will be described below with reference to FIG. 1.

In step S1 shown in FIG. 1, a formed article to be obtained is designed, and data of a formed article model are generated.

In step S2, data of a die model are generated on a CAD system based on the data of the formed article model.

In step S3, NC (numerical control) data for controlling an NC (numerically controlled) machine tool are generated based on the die model data.

In step S4, a die is produced as a tryout die by the NC machine tool based on the NC data.

In step S5, a formed article as a prototype article is pressed using the produced tryout die.

In step S6, the prototype article and a forming surface of the die are observed and analyzed, and the die is manually corrected. Specifically, the prototype article is observed and analyzed for wrinkles, cracks, and dimensional errors, while the die is observed and analyzed for pressing surface conditions. The die is corrected on the basis of a general evaluation of the prototype article and the die. Steps S5, S6 may be repeated several times.

In step S6, the die may develop pores in the surface thereof because of corrections performed on the die, and may also suffer from scratches and steps produced for certain reasons. Depending on design conditions, the die may also have screw holes for attaching parts thereto. Such pores, scratches, steps, and screw holes should not be reflected in the shape surface data used for three-dimensional machining.

In step S7, the shape of the corrected die (workpiece) is three-dimensionally measured by a contactless-type optical three-dimensional measuring instrument, thereby producing three-dimensional measured data made up of a group of points. The shape of the corrected die may alternatively be measured by another measuring instrument, such as a contact-type three-dimensional measuring instrument.

In step S7, pores, scratches, steps, and screw holes, which are present on the die, also are measured, and the data therefrom serve as noise areas, which are not to be reflected in the shape surface data.

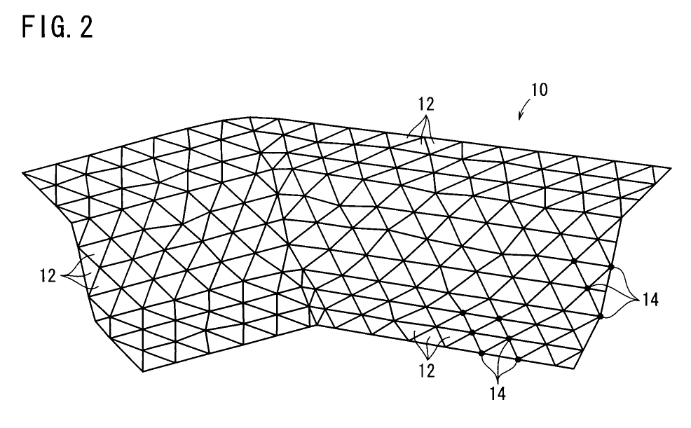

In step S8, the group of points of the three-dimensional measured data is set as a number of triangular polygons (mesh elements) by a predetermined means using a computer, thereby producing mesh data. Such triangular polygons represent the surface shape of the die that has been measured. The mesh data produced in step S8 includes noise areas therein. FIG. 2 shows mesh data 10 by way of example. The mesh data 10 comprises a number of triangular polygons 12 representing the surface shape of the die. Any two polygons 12 that are adjacent to each other have respective sides of equal length, which serve as a shared side. Each of the polygons 12 is of a triangular shape having vertices, which serve as nodes 14.

After the above preceding process, the method of determining mesh data according to the present embodiment for identifying noise areas is carried out. A basic concept of the method for determining mesh data will be described on a two-dimensional surface below.

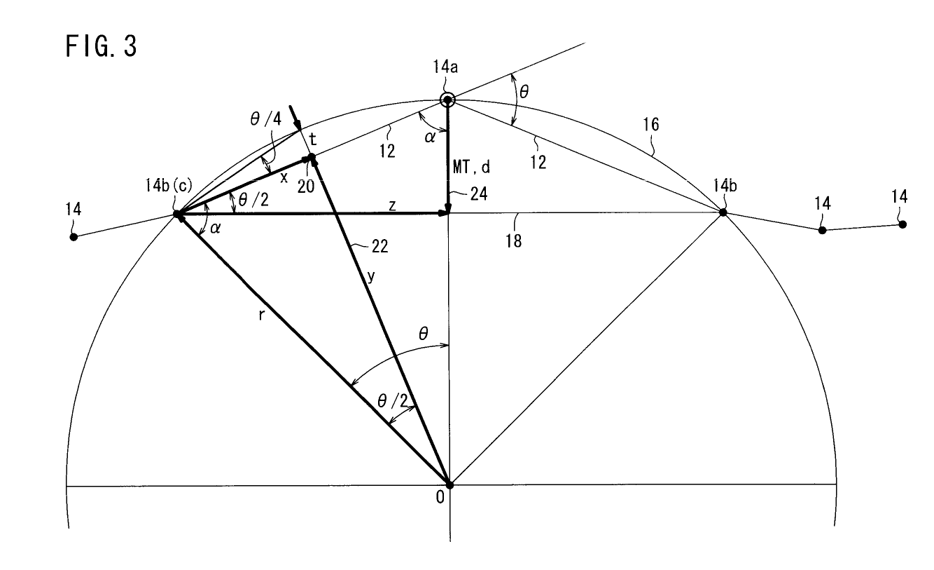

As shown in FIG. 3, when a plurality of nodes 14 are expressed on one surface, one of the nodes 14 is selected as a reference node 14a, whereas two nodes 14 which are adjacent to the reference node 14a are selected as adjacent nodes 14b. A circle 16, which is held in contact with the reference node 14a and the two adjacent nodes 14b and has a radius r, and a reference line 18 interconnecting the two adjacent nodes 14b, are defined.

When a die is machined by the cutter of a machine tool based on the mesh data 10, the cutter does not move along the sides of the polygons 12, but moves along smooth curves interconnecting the polygons 12. Therefore, the circle 16 is substantially equal to the path along which the cutter moves.

Next, attention is focused on the left one of the two adjacent nodes 14b, which will be referred to as “adjacent node 14c”. The angle subtended at the center O of the circle 16 by a straight line extending between the adjacent node 14c and the reference node 14a is represented by θ. A straight line 22 is drawn through a midpoint 20 on the straight line between the adjacent node 14c and the reference node 14a and the center O of the circle 16. The distance between the circle 16 and the midpoint 20 along the straight line 22 is referred to as a “shape tolerance t”. Since the shape tolerance t represents the distance between the path along which the cutter moves and the polygon 12, it is desirable for the shape tolerance t to be as small as possible. However, it is not reasonable to reduce the shape tolerance t excessively, when compared to the machining accuracy of the machine tool. Therefore, the shape tolerance t is set to an appropriately small value, which is based on the machining accuracy of the machine tool.

The adjacent node 14c, the midpoint 20, and the center O jointly form a right triangle. On the right triangle, the distance between the adjacent node 14c and the midpoint 20 is represented by x, and the distance between the midpoint 20 and the center O is represented by y. On the reference line 18, the distance between the adjacent node 14c and a point where a line from the reference node 14a perpendicularly intersects with the reference line 18 is represented by z. The reference node 14a, the adjacent node 14c, and the center O jointly form an isosceles triangle having two equal angles α. The perpendicular line 24 has a length MT (hereinafter referred to as “threshold MT”), which is calculated as follows:

x=r×sin(θ/2)

z=r×sin θ

t=x×tan(θ/4)

MT=z×tan(θ/2)

The above equations are modified into the following equation:

MT=t×4

Therefore, the threshold MT is defined as four times the shape tolerance t. As described later, the threshold MT may be defined as 0<MT≦t×4. That is, the threshold MT may be defined as four times the shape tolerance t or less.

The mesh data 10 are originally obtained by measuring a first die. Theoretically, therefore, the shape tolerance t should not be excessively large. However, the mesh data 10 may include areas where the shape tolerance t is excessively large. Within such areas, the reference node 14a may be judged as noise caused by pores, scratches, steps, or screw holes in the die.

Noise areas of the mesh data 10 are identified based on the above concept. Since the mesh data 10 does not comprise data of surfaces, but comprises a set of data made up of the nodes 14, it is difficult to directly determine the shape tolerance t for identifying noise areas. However, it is desirable to identify noise areas according to a threshold based on the shape tolerance, i.e., the threshold MT of the perpendicular line 24. According to the threshold MT, furthermore, a plurality of polygons 12, which are present around the reference node 14, may be checked together for noise areas. FIG. 3 is illustrative of the relationship between the shape tolerance t and the threshold MT. While the threshold MT is of a fixed value, the length d of the perpendicular line 24 is variable.

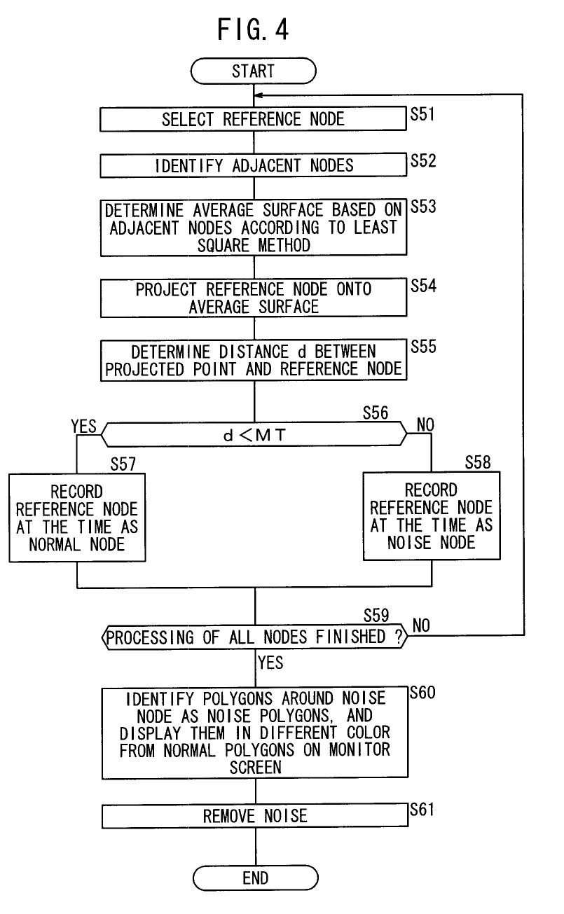

The method of determining mesh data according to the present embodiment will be described below with reference to the sequence shown in FIG. 4. Basically, the sequence shown in FIG. 4 is automatically carried out by a computer under a program. All steps of the sequence may not necessarily be executed by a single computer. For example, the display process in step S60 may be carried out by a computer dedicated for displaying information. The noise removing process in step S61 may be manually carried out wholly or in part.

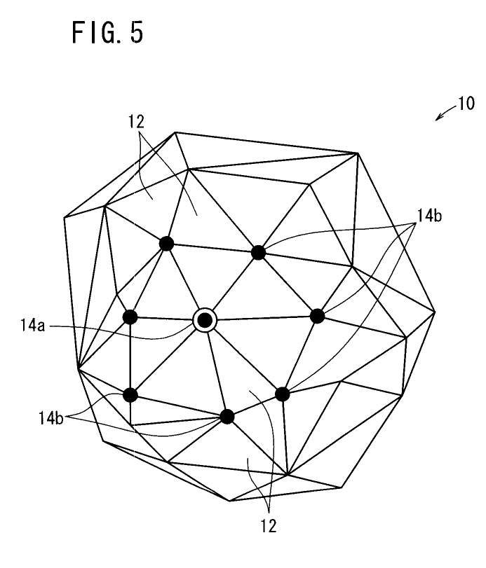

In step S51 shown in FIG. 4, a reference node 14a is selected as a point to be evaluated from among all the nodes 14a included within the mesh data 10, as shown in FIG. 5. Step S51 is included in a loop process to be described below. In step S51, either one of the unprocessed nodes 14 is selected as a reference node 14a.

In step S52, all adjacent nodes 14b that are adjacent to the reference node 14a, with one sides of polygons 12 being interposed therebetween, i.e., all one-ball nodes that are adjacent to the reference node 14a, are identified. In the example shown in FIG. 5, seven polygons 12 are present around the reference node 14a, and hence there are seven adjacent nodes 14b adjacent to the reference node 14a. In general, there are three or more adjacent nodes 14b adjacent to a given reference node 14a.

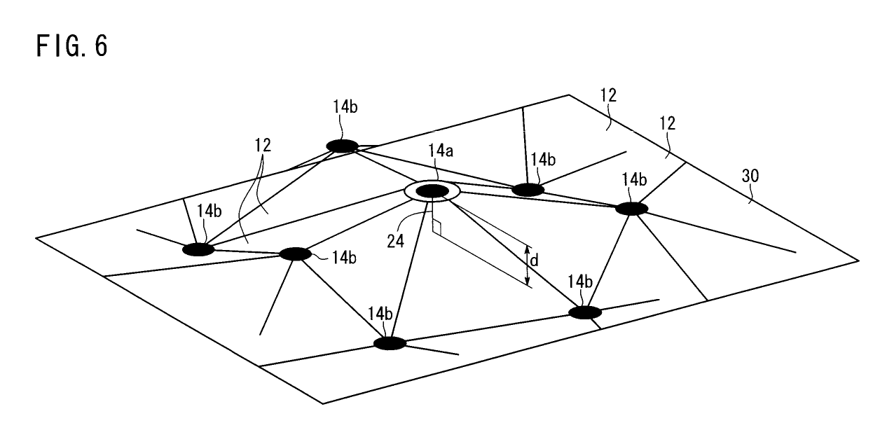

In step S53, an average surface 30 is determined based on all of the identified adjacent nodes 14b according to a least square method, as shown in FIG. 6. The least square method makes it possible to determine the average surface 30 appropriately, and also makes it easy to perform subsequent processes. The average surface 30 corresponds to the reference line 18 shown in FIG. 3. The reference node 14a may not be included in the least square method that determines the average surface 30. The reference node 14a may be present above the average surface 30, below the average surface 30, or on the average surface 30.

Although the average surface 30 is basically a flat surface, the average surface 30 may be approximated by a curved surface depending on design conditions.

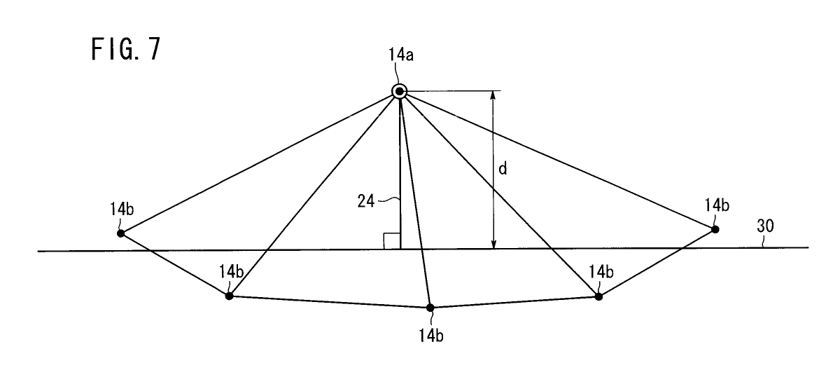

In step S54, the reference node 14 is projected onto the average surface 30 to define a perpendicular line 24, as shown in FIG. 7.

In step S55, the distance d between a point where the reference node 14 is projected onto the average surface 30 and the reference node 14, i.e., the length of the perpendicular line 24, is determined. The distance d may be determined in the same manner, irrespective of whether the reference node 14a is present above the average surface 30 or below the average surface 30.

In step S56, the distance d and the threshold MT are compared with each other. If d<MT, then control goes to step S57. If d≧MT, then control goes to step S58. Although the threshold MT is equal to 4×t as described above, the threshold MT may be somewhat increased or reduced depending on design conditions.

In step S57, the reference node 14a at present is recorded as a normal node.

In step S58, the reference node 14a at present is recorded as a noise node.

After step S57 or step S58, control proceeds to step S59, which determines whether all the nodes 14 included within the mesh data 10 have been processed as a reference node 14a or not. If all the nodes 14 have been processed, then control goes to step S60. If any of the nodes 14 remain unprocessed, then control goes back to step S51.

Basically, the above determining method is performed on all of the nodes 14 included within the mesh data 10. Depending on design conditions, however, for better efficiency, the determining method may not be carried out on a certain range of nodes 14.

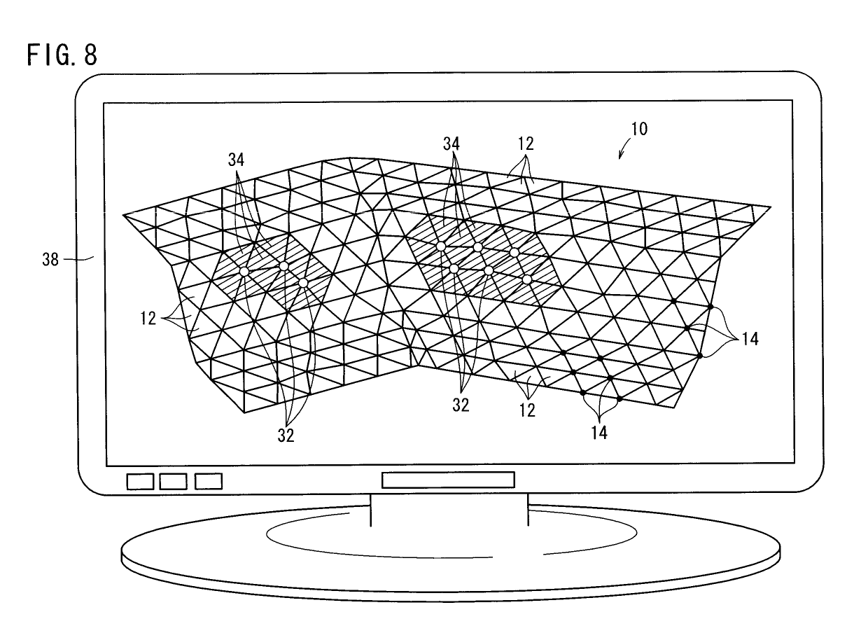

In step S60, as shown in FIG. 8, all polygons 12 disposed around the nodes 14 that have been recorded as noise nodes 32 are identified as noise polygons (noise elements) 34. Stated otherwise, any polygons 12 having at least one of the three nodes 14 thereof identified as a noise node 32 may be identified as noise polygons 34.

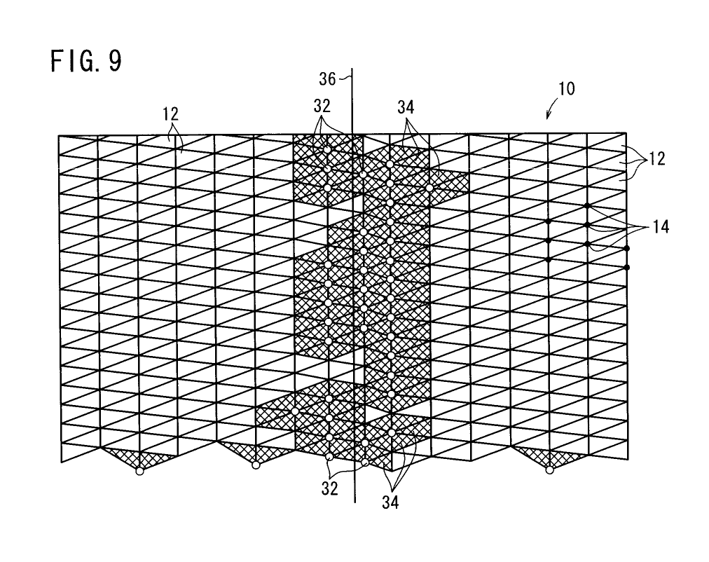

The noise polygons 34 are displayed in a color different from that of the normal polygons 12 on a monitor screen 38 of the computer, thus allowing the operator of the computer to easily recognize the results of the determining method. As shown in FIG. 8, certain ranges of polygons can be identified as noise areas within the mesh data 10. In FIG. 8 (and also FIG. 9), the noise nodes 32 are shown as blank circles, whereas the noise polygons 34 are shown in hatching.

In step S61, the portions of the mesh data 10 that have been identified as the noise areas are processed by a predetermined smoothing process, thereby removing the noise. Thereafter, the sequence shown in FIG. 4 is completed. The mesh data 10 thus determined and processed makes it possible to generate highly accurate die machining data, which is free of noise.

The inventor of the present invention applied the method of determining mesh data according to the present embodiment to a sample workpiece, which had a low straight step. FIG. 9 is a plan view of mesh data 10 produced as a result of application of the method of determining mesh data to the sample workpiece. In FIG. 9, noise polygons 34 are shown in hatching, and the vertical line 36 represents the step. It can be seen that the noise polygons 34 are arranged along the vertical line 36, spreading across a width that can easily be recognized. It can also be understood that the method of determining mesh data according to the present embodiment is particularly effective for a continuous noise pattern, such as the vertical line 36.

The inventor of the present invention also reviewed several determining methods, other than the method of determining mesh data according to the present embodiment. One of such other determining methods is a determining process based on the size of an angle θ formed by two polygons 12. According to this method, if the angle θ is excessively large, then polygons 12 on opposite sides of the angle θ are determined as noise polygons.

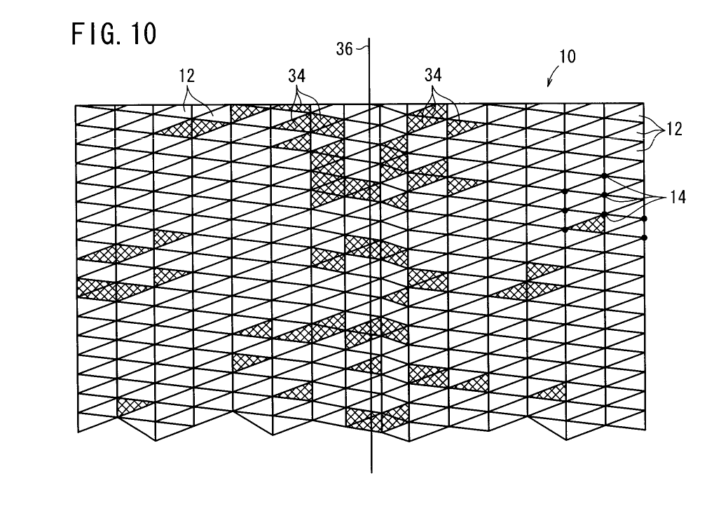

FIG. 10 is a plan view of mesh data 10 produced as a result of application of the method based on the size of the angle θ to the sample workpiece shown in FIG. 9. Since the determining process is carried out based on a side shared by two of the polygons 12, only two polygons may be determined as noise polygons upon application of a single cycle of the determining process, and noise polygons determined by successive cycles of the determining process do not tend to provide a significant pattern. A comparison of FIGS. 9 and 10 indicates that the vertical line 36 cannot clearly be recognized in FIG. 9, and thus the method of determining mesh data according to the present embodiment is more effective. However, the determining method illustrated in FIG. 10 may be effective in certain applications, such as for identifying small discrete noises.

With the method of determining mesh data according to the present embodiment, as described above, since all polygons 12, including the reference node 14a where the distance d between the average surface 30 and the reference node 14a is equal to or greater than the threshold MT, are identified as noise polygons, noise areas within the mesh data 10 can automatically be identified simply and reliably using a computer.

As shown in FIG. 4, the determining process for one reference node 14a basically is carried out by identifying adjacent nodes 14b, determining the average surface 30, calculating the distance d, and comparing the distance d with the threshold MT. Therefore, the determining process is simple and does not pose an undue burden on the computer.

The mesh elements of the mesh data 10 comprise triangular polygons 12, which are easier to process than polygons of other shapes, e.g., rectangular polygons.

While the amount of mesh data 10 is large, noise areas within the mesh data 10 basically are identified using the computer in the method of determining mesh data according to the present embodiment. Consequently, any burden on the computer operator is small, and the operator finds it easy to learn how to operate the computer for carrying out the method of determining mesh data according to the present embodiment.

The method of determining mesh data according to the present invention is not limited to the above-illustrated details, but various changes and modifications may be made to the method without departing from the scope of the invention.

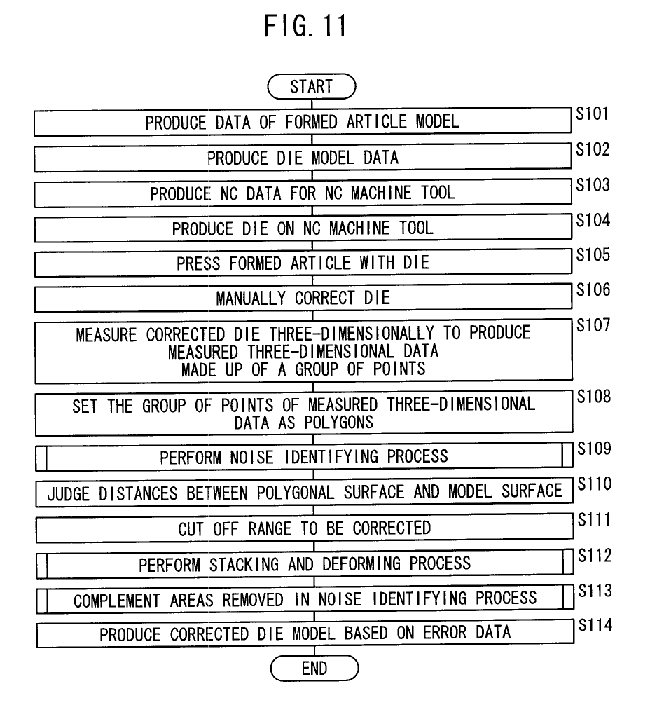

A method of correcting model data according to an embodiment of the present invention will be described below with reference to FIGS. 11 through 24.

In step S101 shown in FIG. 11, a formed article to be obtained is designed, and data of the formed article model are generated.

In step S102, data of a die model are generated on a CAD system based on the data of the formed article model.

In step S103, NC (numerical control) data for controlling an NC (numerically controlled) machine tool are generated based on the die model data.

In step S104, a die is produced by the numerically controlled machine tool based on the NC data.

In step S105, a formed article as a prototype article is pressed using the produced die.

In step S106, the prototype article and a pressing surface of the die are observed and analyzed, and the die is manually corrected. Specifically, the prototype article is observed and analyzed for wrinkles, cracks, and dimensional errors, while the die is observed and analyzed for pressing surface conditions. The die is corrected on the basis of a general evaluation of the prototype article and the die. Steps S105, S106 may be repeated several times.

In step S107, the shape of the corrected die is three-dimensionally measured by a measuring instrument such as a three-dimensional digitizer or the like, thereby producing three-dimensional measured data made up of a group of points. The measuring instrument may be of a contact-type or a contactless-type.

In step S108, the group of points of the three-dimensional measured data is set as a number of polygons by a predetermined means using a computer. Such polygons represent the surface shape of the die that has been measured. Each of the polygons primarily is represented by a triangular plane.

In step S109, a noise identifying process is performed for identifying and removing noise locations within the three-dimensional measured die data. The noise identifying process is carried out according to the above determining method.

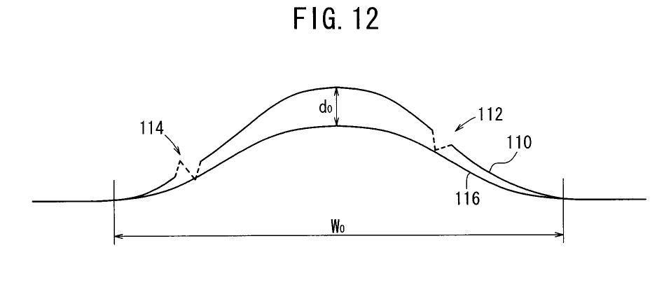

In the noise identifying process, noise areas 112, 114 are removed from a measured data surface (second surface) 110, as shown in FIG. 12. No data are present within the removed areas.

The computer compares the three-dimensional measured data, which has been converted into polygons, and the die model data with each other, and brings a measured data surface (second surface) 110 represented by the polygons based on the three-dimensional measured die data into close proximity to a model surface (first surface) 116 represented by the die model data. For example, the measured data surface may be sufficiently brought, in its entirety, into close proximity to the model surface, such that the average distance between the measured data surface and the model surface becomes substantially minimum. When the measured data surface and the model surface are brought into close proximity to each other, areas of the surfaces where the die is not corrected (i.e., the areas other than the range Wₒ shown in FIG. 12), essentially are placed in face-to-face contact with each other.

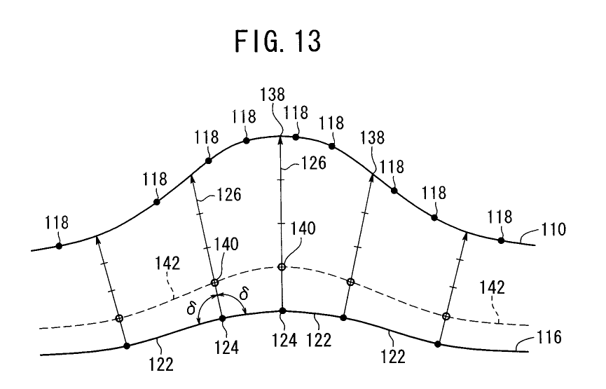

As shown in FIG. 13, the measured data surface 110 comprises a collection of polygons 122 having vertices represented by a number of measured points 118. Since the measured data surface 110 is produced by measuring an actual first die, the measured data surface 110 has a slightly rough surface due to small machining marks and measurement errors caused by the measuring instrument.

The model surface 116 also comprises a number of polygons 122. In FIG. 13, and in other subsequent figures corresponding thereto, the measured data surface 110 and the model surface 116 are schematically shown as lines.

In step S110, distances between the measured data surface and the model surface are judged at a plurality of corrective points. Specifically, the distances d₀ (see FIG. 12) between the measured data surface and the model surface may be determined completely over the entirety thereof.

In step S111, differences between the measured data surface and the model surface at a plurality of reference locations are judged, and thereafter, a range to be corrected is cut off. Specifically, the distances d₀ between the measured data surface and the model surface are judged, and a range to be corrected is identified. The range to be corrected represents a range W₀, which corresponds to an area where the die is to be corrected. The range W₀ to be corrected is automatically identified by the computer. A subsequent stacking and deforming process is limited only to the range W₀. Consequently, even if the die model data represents a die for machining a workpiece having a wide area, such as an automobile body, the die model data can be processed rapidly.

The threshold for the distances d₀ may be within a range from 0.01 mm to 0.5 mm, and more preferably from 0.05 mm to 0.2 mm. For example, the threshold may be set to 0.1 mm, for the purpose of reducing the range W₀ as small as possible, and for maintaining the accuracy of the data which is ultimately obtained. The range W₀ may be set to a value having a certain wider pitch, to provide areas for connection to surrounding regions.

In step S112, a stacking and deforming process is performed. The stacking and deforming process will be described later.

In step S113, a complementing process is carried out on the noise locations (noise areas 112, 114 shown in FIG. 12), which have been removed by the noise identifying process. The complementing process will be described later.

In step S114, the die model is deformed to produce a corrected die model based on absolute values of distances from the measuring points of the three-dimensional measured data of the die, which have been obtained in step S107, to the die model (i.e., data of the errors). Since the die model data are modified based on data of the errors, die model data are generated, which take over the adjacency information and curves of the original data. Consequently, even if there are some missing measuring points, die model data are easily recovered and restored based on shapes around such missing measuring points.

The modified die model thus produced reflects a considerable amount of information concerning the shape of the die, which is corrected in step S106, based on a prototype article that actually has been produced at least once. Therefore, the man-hours required to correct the die model for producing a repetitive die are greatly reduced. In other words, NC data are generated based on the modified die model, and a repetitive die, which is produced by an NC machine tool based on the NC data, reflects the shape of the die that is corrected in step S106. Consequently, the repetitive die thus produced is not required essentially to be corrected. Hence, highly accurate articles can be manufactured by the repetitive die.

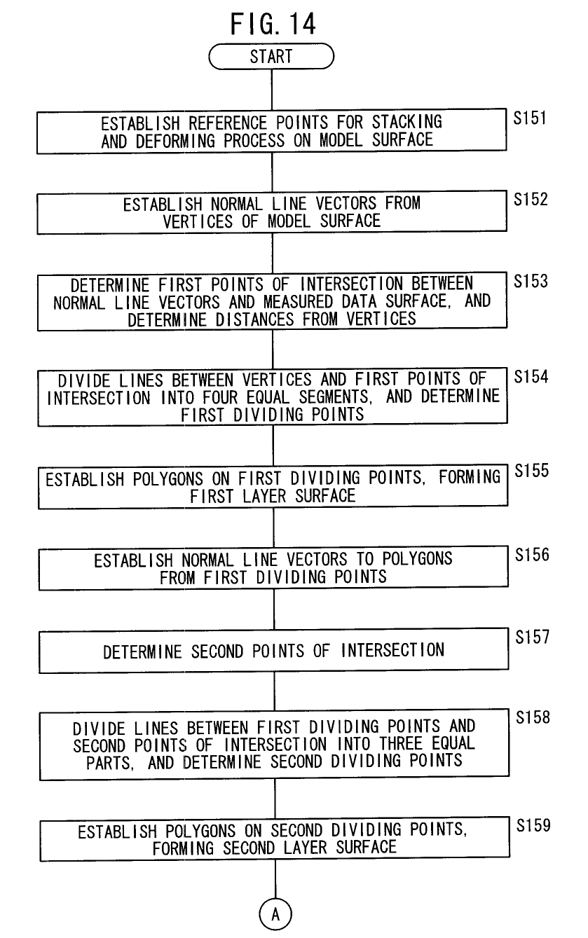

The stacking and deforming process in step S112 will be described below with reference to the flowchart shown in FIG. 14. The stacking and deforming process is referred to as such because intermediate surfaces in three layers are stacked and modified with respect to the original measured data surface 110.

In step S151 shown in FIG. 14, reference points for the stacking and deforming process are set on the model surface 116. In the illustrated embodiment, vertices 124 of the polygons 122 are used as reference points, as shown in FIG. 13.

In step S152, lines 126 are established respectively as normal vectors to the measured data surface 110 from respective vertices 124 on the model surface 116. Specifically, the lines 126 as normal vectors are established such that angles δ between the lines 126 and adjacent segments of the model surface 116 are equal to each other.

Since the vertices 124 are defined as vertices of three or more polygons 122, the lines 126 as normal vectors may be set such that the angles between the lines 126 and the adjacent polygons 122 are equal to each other, as much as possible.

For higher accuracy, the lines 126 as normal vectors may be determined by a weighted average of the adjacent segments of the model surface 116.

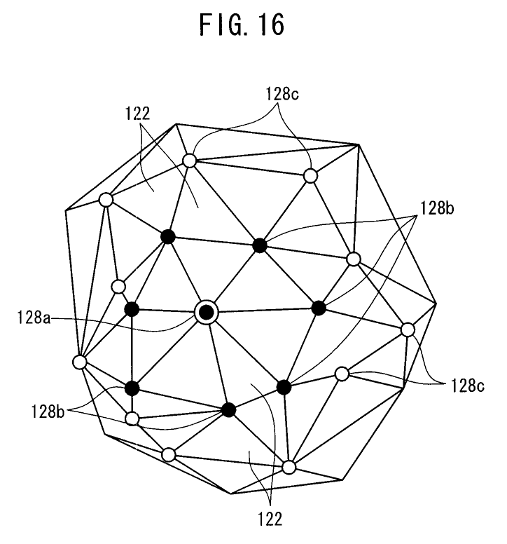

Specifically, as shown in FIG. 16, one-ball-node points 128b and two-ball-node points 128c are extracted with respect to a reference point 128a. A one-ball node defines a point, which is connected to the point 128a by a single line, and is indicated as a black dot in FIG. 16. A two-ball node defines a point, which is connected to the point 128a by two lines or less, and is indicated as a white dot in FIG. 16. In FIG. 16, there are eight one-ball-node points 128b and eleven two-ball-node points 128c. Therefore, there are 19 one-ball-node and two-ball-node points all together.

Numbers j (j=1 through 19) are assigned to the one-ball-node and two-ball-node points, thus making the corresponding point vectors 134 identifiable as points nⱼ. Linear distances dⱼ from the point 128a to the respective points nⱼ are determined.

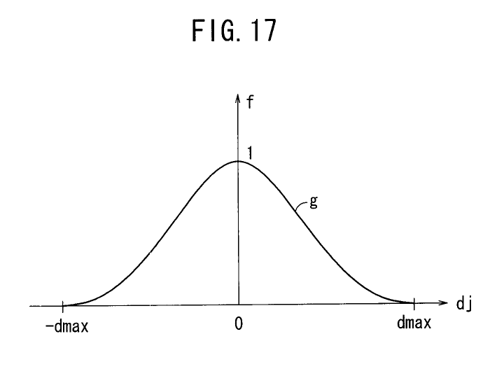

The vectors nⱼ of the one-ball-node and two-ball-node points are weighted depending on the distances dⱼ in order to determine point representative vectors n′ⱼ as weighted averages, according to the following equation (1):

$${n}^{′} = \frac{{\sum }_{j = 0}^{m} {n}_{j} \cdot f ( {d}_{j} ( {n}_{j} ) )}{m} \qquad ( 1 )$$

where m is a parameter representing the total number of one-ball-node and two-ball-node points, i.e., m=19 in FIG. 16, and f is a weighting function having the distance dⱼ as an argument, as shown in FIG. 17. If the absolute value of the distance dⱼ is equal to or less than a threshold d_{MAX}, then the function f is defined by the following function g. If the absolute value of the distance dⱼ is in excess of the threshold d_{MAX}, then the function f is nil. The function g is a function representing a substantially normal distribution within a range of 0≦g≦1, such that when |dⱼ|=d_{MAX}, g=0, and when dⱼ=0, g=1. In FIG. 17, positive and negative ranges of the distance dⱼ represent face and back sides, respectively, of the surface being processed.

Of the point representative vectors n′ determined according to the equation (1), those vectors of the points which are equal to or greater than three-ball-node points, and those vectors corresponding to points whose distances dⱼ are too large, are excluded. Those vectors of the one-ball-node and two-ball-node points are weighted and averaged depending on the distances dⱼ. Therefore, vectors over smaller distances have a greater effect, thereby providing point representative vectors n′ representative of an appropriate peripheral shape.

In step S153, first points 138 of intersection between the lines 126 and the measured data surface 110 are determined, and distances from the vertices 124 to the first intersecting points 138 are determined.

In step S154, each of the lines 126 between the vertices 124 and the first intersecting point 138 is divided into four equal segments, for example. A first dividing point 140, which is closest to the vertex 124, is determined on each of the lines 126. Stated otherwise, the first dividing point 140 is a point produced when the line 126 is divided at a ratio of 1:3 between the measuring point 118 and the first intersecting point 138. Each of the lines 126 may be divided into at least one segment. That is, each of the lines 126 may be divided at a ratio of 100%.

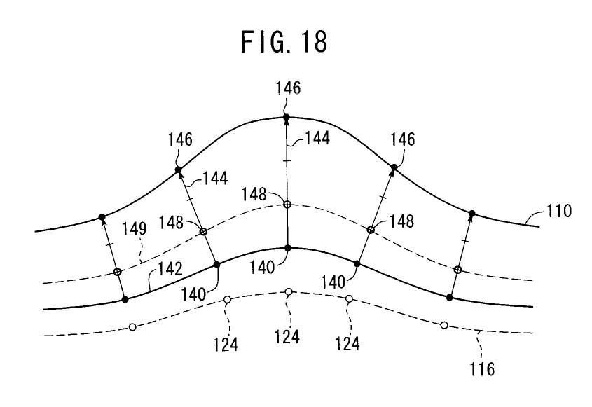

In step S155, while the polygons remain connected based on the original measuring points 118, other polygons are established on corresponding first dividing points 140 on the respective lines 126, thereby providing a first layer surface (moved and corrected surface) 142 represented by those polygons, as shown in FIG. 18. In other words, the vertices 124 are moved along the respective lines 126 to the first dividing points 140, which are at a position divided at the given ratio up to the first intersecting points 138, thus providing a moved and corrected surface.

In steps S151 through S155, both the measured data surface 110 and the model surface 116 needn't be subjected to a smoothing process, but rather may be processed as polygonal surfaces. Therefore, in steps S151 through S155, the measured data surface 110 and the model surface 116 can be processed rapidly.

In step S152, as shown in FIG. 18, lines 144 are established as weighted average lines from the respective first dividing points 140 to the measured data surface 110. Step S152 is similar to step S151, and is equivalent to updating the first layer surface 142 obtained as a moved and corrected surface into the original model surface 116.

In step S157, second points 146 of intersection between the lines 144 and the model surface 116 are determined, and distances from the first dividing points 140 to the second intersecting points 146 are determined, similar to step S152.

In step S158, each of the lines 144 between the first dividing point 140 and the second intersecting point 146 is divided into three equal segments, and a second dividing point 148, which is closest to the first dividing point 140, is determined on each of the lines 144. Stated otherwise, the second dividing point 148 is a point produced when the line 144 is divided at a ratio of 1:2 between the first dividing point 140 and the second intersecting point 146.

In step S159, while the polygons remain connected based on the original measuring points 118, other polygons are established on the second dividing points 148, which have been obtained on the respective lines 144, thereby providing a second layer surface 149 represented by those polygons.

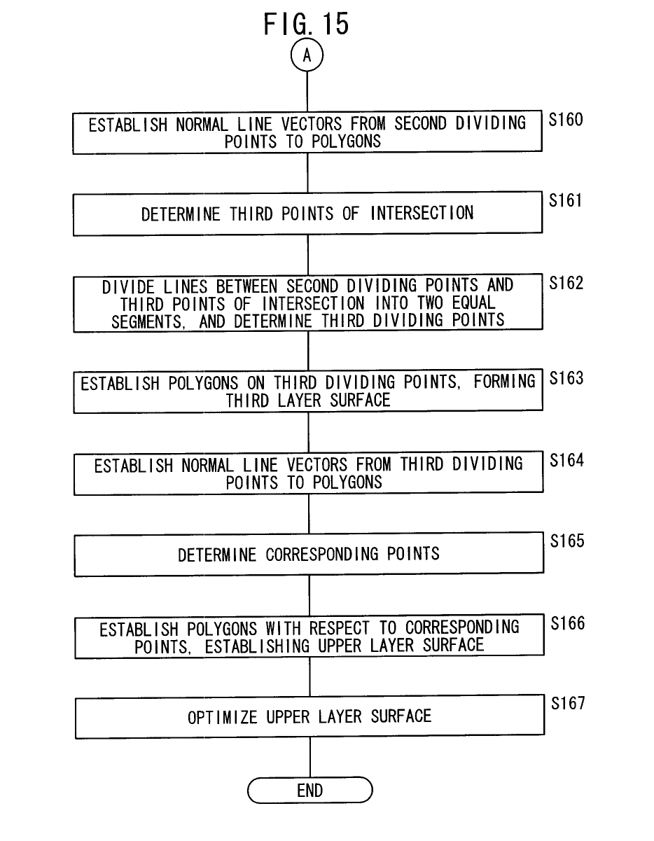

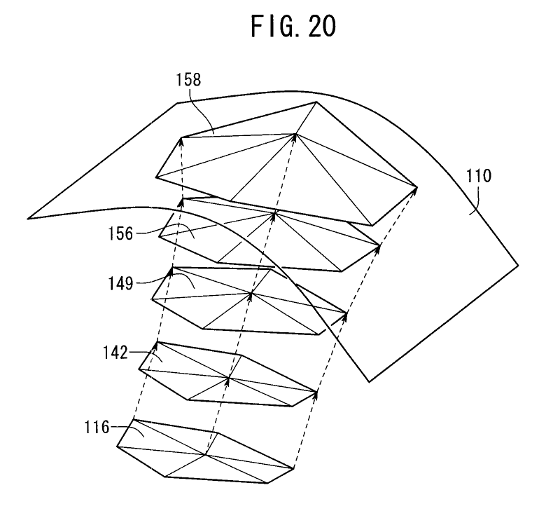

Thereafter, normal vectors to the polygons are established from the second dividing points 148 in step S160 shown in FIG. 15, and third intersecting points are determined in step S161. Lines between the second dividing points 148 and the third intersecting points are divided into two equal segments, and third dividing points are determined in step S162. Then, polygons are established on the third dividing points, thereby providing a third layer surface 156 (see FIG. 20), in step S163.

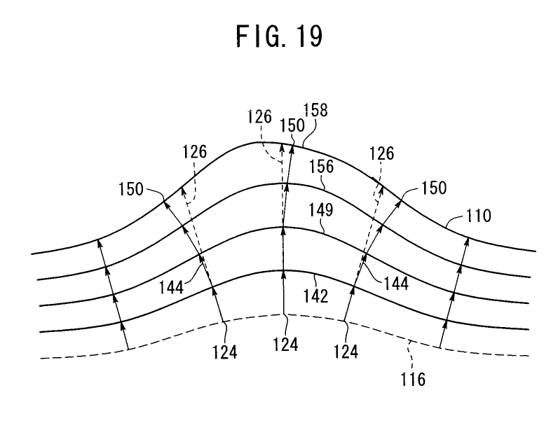

Furthermore, normal vectors to the polygons are established from the third dividing points in step S164, and corresponding points 150 (see FIG. 19) are determined as points of intersection between the normal vectors and the measured data surface 110 in step S165. Then, polygons are established on the corresponding points 150, thereby providing an upper layer surface 158, in step S166.

The process described thus far is illustrated in FIGS. 19 and 20. As can be seen from FIGS. 19 and 20, the original model surface 116 is projected onto the measured data surface 110 through four stages. According to the stacking and deforming process, the original model surface 116 is not projected at once onto the measured data surface 110 along lines 126 that serve as original normal lines, but rather, the original model surface 116 is projected onto the measured data surface 110 in a stepwise fashion, via moved and corrected surfaces that are established at given ratios. Therefore, even if some of the lines 126 cross each other within regions of the measured data surface 110 and the model surface 116 where the radius of curvature is large, the positional relationship between the polygons 122 on the original model surface 116 is maintained and projected onto the measured data surface 110.

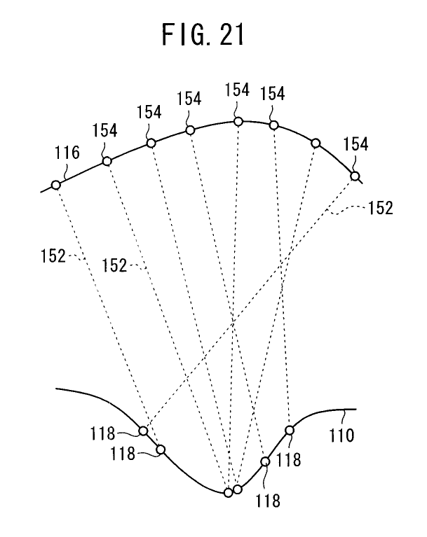

If the stacking and deforming process is not performed, then, as shown in FIG. 21, within regions of the measured data surface 110 or the model surface 116 where the radius of curvature is small, the relationship between corresponding points 154 provided on the model surface 116 by straight lines 152 established from the measuring points 118 to the measured data surface 110 and the measured points 118 may become twisted, thus failing to establish an accurate corrected die model. According to the present embodiment, the stacking and deforming process is free of such a drawback, and corresponding points 150 on the measured data surface 110 are established while substantially maintaining their positional relationship to the measuring points 118 on the measured data surface 110. Therefore, the corresponding points 150 and the measuring points 118 are appropriately associated with each other.

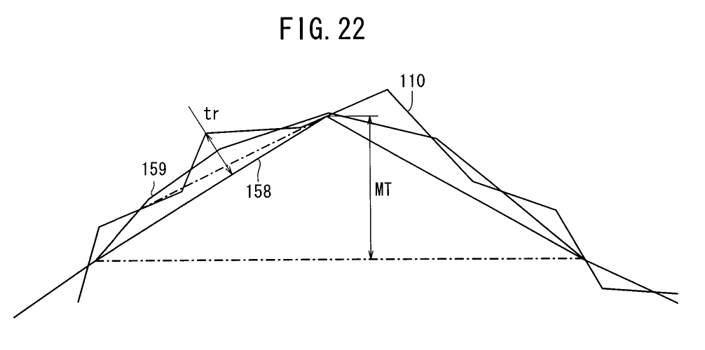

In step S167, as shown in FIG. 22, the upper layer surface 158 that ultimately is formed is optimized to meet predetermined accuracy conditions, e.g., to reduce a tolerance tr depending on a prescribed value MT. The optimizing process may be carried out by setting an appropriately smooth pseudo-curved surface 159 for locations that do not meet the accuracy conditions, recalculating a suitable pitch based on the pseudo-curved surface 159, and then reconstructing the mesh. A surface represented by the reconstructed mesh may be re-projected onto the measured data. The data, which have thus been optimized and guaranteed for accuracy, can be used as CAM data for machining dies.

In FIGS. 13, 18, and 19, the measured data surface 110 is provided on only one side of the model surface 116. However, the measured data surface 110 may also be provided on the other side of the model surface 116, or may partially cross the model surface 116. In the above stacking and deforming process, intermediate surfaces in three layers are provided. However, two or four or more of such intermediate surfaces may be provided. The dividing ratio, which is used as a basis for the dividing points to be determined during the stacking and deforming process, may be set to any desired value. For example, a midpoint (1:1) may be set as a dividing point at all times.

The noise identifying process in step S109 shown in FIG. 11 will be described below. Basically, the noise identifying process comprises the steps of identifying, from mesh data, a reference node and all adjacent nodes that are adjacent to the reference node, with sizes of mesh elements interposed therebetween, determining an average surface with respect to all the adjacent nodes, determining a distance between the average surface and the reference node, and judging the reference node as a normal node if the distance is smaller than a predetermined threshold, or as a noise node if the distance is equal to or greater than the predetermined threshold.

A basic concept of the method for determining mesh data, which has been described in detail above, will briefly be described below.

As shown in FIG. 3, the perpendicular line 24 has a length MT (hereinafter referred to as “threshold MT”), which is calculated as follows:

x=r×sin(θ/2)

z=r×sin θ

t=x×tan(θ/4)

MT=t×4×cos²(θ/4)0<cos(θ/4)≦1

The above expressions are modified into the following expression:

0<MT≦t×4

Therefore, the threshold MT is defined as four times the shape tolerance t or less.

The mesh data 10 are originally obtained by measuring a first die. Theoretically, therefore, the shape tolerance t should not be excessively large. However, the mesh data 10 may include areas where the shape tolerance t is excessively large. Within such areas, the reference node 14a may be judged as noise caused by pores, scratches, steps, or screw holes in the die.

Noise areas of the mesh data 10 are identified based on the above concept. Since the mesh data 10 does not comprise data of surfaces, but comprises a set of data made up of the nodes 14, it is difficult to directly determine the shape tolerance t for identifying noise areas. However, it is desirable to identify noise areas according to a threshold based on the shape tolerance, i.e., the threshold MT of the perpendicular line 24. According to the threshold MT, furthermore, a plurality of polygons 12, which are present around the reference node 14, may be checked together for noise areas. FIG. 3 is illustrative of the relationship between the shape tolerance t and the threshold MT. While the threshold MT is of a fixed value, the length d of the perpendicular line 24 is variable.

If the noise identifying process is applied to a three-dimensional environment, then since a plurality of (three or more) adjacent nodes 14b are present around the reference node 14a, an average surface 30 may be determined based on all of the identified adjacent nodes 14b, according to a least square method, as shown in FIG. 6. The least square method makes it possible to determine the average surface 30 appropriately, and also makes it easy to perform subsequent processes. The average surface 30 corresponds to the reference line 18 shown in FIG. 3. The reference node 14a may not be included in the least square method used to determine the average surface 30. The reference node 14a may be present above the average surface 30, below the average surface 30, or on the average surface 30. Although the average surface 30 is basically a flat surface, the average surface 30 may be approximated by a curved surface, depending on design conditions.

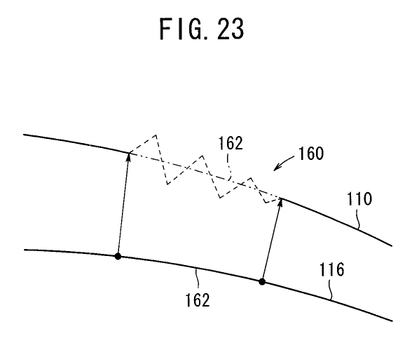

The complementing process in step S113 will be described below with reference to FIG. 23.

A removed area 160, from which noise has been removed, is free of data representing the measured data surface 110. Therefore, a corresponding filling area 162 within the model surface 116 is identified, and the filling area 162 is moved and copied onto the removed area 160. Insofar as the filling area 162 is moved to bring the peripheral edge thereof into matching relation to the peripheral edge of the removed area 160, the filling area 162 may be translated or rotated. Under certain conditions, the filling area 162 may not be moved, but may simply be copied onto the removed area 160.

Thus, the removed area 160 can be complemented simply by the model surface 116 of the corresponding filling area 162, which is copied thereon.

With the method of correcting model data according to the embodiment of the present invention, as described above, either one of the measured data surface 110 and the model surface 116 needn't be subjected to any special smoothing process during the projecting process (steps S151 through S166). Therefore, the model surface 116 can simply and efficiently be corrected in order to match the measured data surface 110. According to the results of a tryout conducted by the inventor, the method of correcting model data according to the present embodiment, as the method was applied to a die having a predetermined size, had a processing time reduced by about ⅙ while the conventional level of accuracy was maintained, as compared with the method of correcting a surface while smoothing the same according to the sequence disclosed in Japanese Laid-Open Patent Publication No. 2008-176441.

The model data thus corrected can also be used for performing an FEM analysis.

A process, in which the present invention is applied to stages of making an external design for a vehicle, will be described below.

For making an external design of a vehicle, model data may be prepared in any of designing stages, and a clay model generated based on the model data may be corrected by the designer. In this case, the corrected clay data may be reflected in the model data.

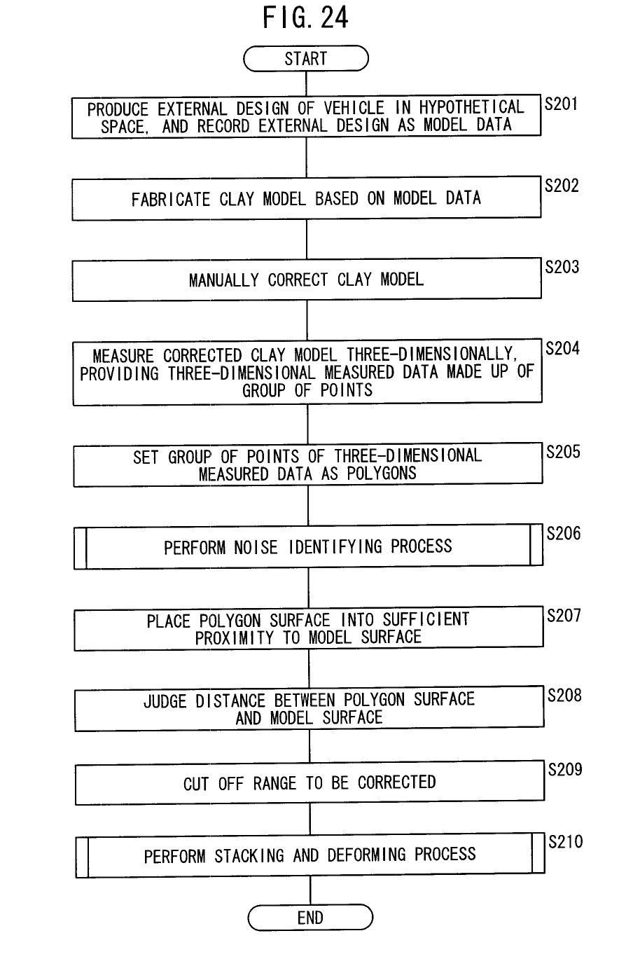

In step S201 shown in FIG. 24, the designer produces an external design of a vehicle in a hypothetical space on a computer. After several reviews have been made, an external design in a first stage is determined. The external design thus determined is recorded as model data. Modern computers have high processing capability, and can easily and rapidly make such three-dimensional designs.

The model data thus produced has a considerably sophisticated design. However, the design generated on the computer can be seen only on a display monitor or by means of a printout. Since the model data are required to be analyzed three-dimensionally, the model data are processed as follows:

In step S202, a clay model (actual model) is fabricated based on the model data.

In step S203, the clay model is observed and corrected based on a three-dimensional analysis of the external design thereof. The clay model is manually corrected by the designer or by other workers. Steps S202, S203 may be carried out repeatedly a plurality of times. A small clay model may initially be fabricated, and a life-size clay model may subsequently be fabricated thereafter.

In step S204, the corrected clay model is three-dimensionally measured using a measuring instrument, so as to produce three-dimensional measured data made up of a group of points. Step S204 is essentially the same as step S7 described above, except that an actual model, rather than a die, is measured.

The subsequent steps S205 through S210 are the same as steps S108 through S112 (see FIG. 11), which have been described above. Therefore, the noise identifying process in step S206 is performed as shown in FIGS. 3 and 6, whereas the stacking and deforming process in step S210 is performed as shown in FIGS. 14 and 15.

The data thus obtained can be used as die model data for producing the die as shown in FIG. 11. The data may also be used for reproducing the clay model again for certain reasons, or may be used for conducting an FEM analysis.

The above method of correcting model data is not limited to being applied to automobile bodies, but also may be applied to smaller products.

The method of correcting model data according to the present invention is not limited to the illustrated details, but various changes and modifications may be made to the method without departing from the scope of the invention.

1. A method of correcting model data, comprising the steps of:
correcting a die fabricated based on reference model data, and measuring the corrected die with a measuring instrument to provide three-dimensional measured die data; and
placing the three-dimensional measured die data and the model data in proximity to each other, and projecting a first surface represented by the model data onto a second surface represented by the three-dimensional measured die data using a computer;
wherein the step of projecting the first surface comprises the steps of:
a first step of determining normal lines or average normal lines including peripheral areas with respect to a plurality of reference points set on the first surface;
a second step of determining intersecting points between the normal lines or the average normal lines and the second surface; and
a third step of moving the reference points along the normal lines or the average normal lines to a position at a predetermined ratio up to the intersecting points, thereby providing a moved and corrected surface.

2. The method according to claim 1, wherein the moved and corrected surface is updated as the first surface, and the first step, the second step, and the third step are repeated a plurality of times.

3. The method according to claim 1, wherein the reference points represent vertices of polygons that make up the first surface, and the average normal line vectors represent vectors produced by a weighted average of normal lines at vertices of polygons including the reference points, and extending within a predetermined range around the reference points.

4. The method according to claim 1, further comprising the step of:
after the step of projecting the first surface, performing an optimizing step to generate meshes based on a pseudo-curved surface in order to cause the moved and corrected surface, which is ultimately produced, to match predetermined accuracy conditions.

5. The method according to claim 1, wherein the step of projecting the first surface is performed only within a range of the first surface, which corresponds to an area in which the die is corrected.

6. The method according to claim 5, wherein the range of the first surface, which corresponds to the area in which the die is corrected, is defined based on the distance between the first surface and the second surface after the three-dimensional measured die data and the model data are placed in proximity to each other.

7. The method according to claim 6, wherein a threshold for the distance between the first surface and the second surface, which defines the range of the first surface that corresponds to the area in which the die is corrected, is in a range from 0.05 mm to 0.2 mm.

8. The method according to claim 1, further comprising the steps of:
identifying noise areas within the three-dimensional measured die data, and removing the identified noise areas from the three-dimensional measured die data using a computer; and
copying areas of the first surface, which correspond to the noise areas removed from the three-dimensional measured die data, onto portions of the three-dimensional measured die data from which the noise areas are removed.

9. A method of correcting model data, comprising the steps of:
correcting an actual model fabricated based on reference model data and measuring the corrected actual model with a measuring instrument to provide three-dimensional measured actual model data; and
placing the three-dimensional measured actual model data and the model data in proximity to each other, and projecting a first surface represented by the model data onto a second surface represented by the three-dimensional measured actual model data using a computer;
wherein the step of projecting the first surface comprises the steps of:
a first step of determining normal lines or average normal lines including peripheral areas with respect to a plurality of reference points set on the first surface;
a second step of determining intersecting points between the normal lines or the average normal lines and the second surface; and
a third step of moving the reference points along the normal lines or the average normal lines to a position at a predetermined ratio up to the intersecting points, thereby providing a moved and corrected surface.

10. The method according to claim 9, wherein the moved and corrected surface is updated as the first surface, and the first step, the second step, and the third step are repeated a plurality of times.

11. The method according to claim 9, wherein the reference points represent vertices of polygons that make up the first surface, and the average normal line vectors represent vectors produced by a weighted average of normal lines at vertices of polygons including the reference points, and extending within a predetermined range around the reference points.

12. The method according to claim 9, further comprising the step of:
after the step of projecting the first surface, performing an optimizing step to generate meshes based on a pseudo-curved surface in order to cause the moved and corrected surface, which is ultimately produced, to match predetermined accuracy conditions.

13. The method according to claim 9, wherein the step of projecting the first surface is performed only within a range of the first surface, which corresponds to an area in which the actual model is corrected.

14. The method according to claim 13, wherein the range of the first surface, which corresponds to the area in which the actual model is corrected, is defined based on the distance between the first surface and the second surface after the three-dimensional measured actual model data and the model data are placed in proximity to each other.

15. The method according to claim 14, wherein a threshold for the distance between the first surface and the second surface, which defines the range of the first surface that corresponds to the area in which the actual model is corrected, is in a range from 0.05 mm to 0.2 mm.

16. The method according to claim 9, further comprising the steps of:
identifying noise areas within the three-dimensional measured actual model data, and removing the identified noise areas from the three-dimensional measured actual model data using a computer; and
copying areas of the first surface, which correspond to the noise areas removed from the three-dimensional measured actual model data, onto portions of the three-dimensional measured actual model data from which the noise areas are removed.

17. A method of determining mesh data by measuring a surface shape of a workpiece with a measuring instrument to produce mesh data made up of a plurality of mesh elements, and thereafter identifying noise areas within the mesh data using a computer, the method comprising the steps of:
a first step of identifying, within the mesh data, a predetermined reference node and all adjacent nodes that are adjacent to the reference node, with sides of the mesh elements interposed therebetween;
a second step of determining an average surface with respect to the all adjacent nodes;
a third step of determining a distance between the average surface and the reference node; and
a fourth step of judging the reference node as a normal node if the distance is smaller than a predetermined threshold, or as a noise node if the distance is equal to or greater than the predetermined threshold.

18. The method according to claim 17, wherein the average surface is determined based on all the adjacent nodes according to a least square method.

19. The method according to claim 17, further comprising the step of:
after the fourth step, identifying all mesh elements around the noise node as noise elements.
